(19) United States
(12) Patent Application Publication
(10) Pub. No.: US 2015/0127295 A1
(43) Pub. Date: May 7, 2015

(54) MOVING-BODY-ABNORMAL-NEARING DETECTION SYSTEM AND MOVING-BODY-ABNORMAL-NEARING DETECTION METHOD

(71) Applicant: NEC CORPORATION, Tokyo (JP)

(72) Inventors: Sachio Teramoto, Tokyo (JP); Tomohito Ando, Tokyo (JP); Hiroki Tagato, Tokyo (JP); Koji Kida, Tokyo (JP)

(21) Appl. No.: 14/394,517

(22) PCT Filed: May 20, 2013
(86) PCT No.: PCT/JP2013/003191

§ 371 Date: Oct. 15, 2014

(30) Foreign Application Priority Data
Jun. 13, 2012 (JP) 2012-133864

(51) Int. Cl. G01B 21/16

(52) U.S. Cl. CPC G01B 21/16
USPC 702/150

(57) ABSTRACT

There is provided a moving-body-abnormal-nearing detection system capable of determining whether abnormal nearing between moving bodies will occur in a short processing time. A projection matrix calculation means 71 calculates a first projection matrix indicating mapping from a 3D space onto a 2D plane based on period information of a first moving body and period information of a second moving body. An abnormal nearing determination means 72 maps the period information of the first moving body to a line segment in the 2D plane by use of the first projection matrix. It then determines whether abnormal nearing between the first moving body and the second moving body will occur by determining how a circle whose center is a passage position of the second moving body and whose radius takes a threshold as a determination standard as to whether abnormal nearing will occur crosses with the line segment.

### TECHNICAL FIELD

The present invention relates to a moving-body-abnormal-nearing detection system for detecting abnormal nearing between moving bodies, a moving-body-abnormal-nearing detection method therefor, and a moving-body-abnormal-nearing detection program therefor.

### BACKGROUND ART

In recent years, air traffics are increasing and abnormal nearing (conflict) between aircrafts can occur. Therefore, an air control technique for solving a congestion state on a course is being increasingly expected. One of the most important basic functions in the air control technique is to detect accurate conflict information.

Conflict is a situation in which two aircrafts cruising at the same altitude near to each other within a distance set for securing safety (oceanic airspace). A controller needs to detect accurate conflict information (such as aircrafts to conflict, conflict occurrence time, occurrence place, and acceleration/deceleration information for avoiding conflict) in order to make a control instruction to each aircraft.

NPL 1 describes therein a simulation-based conflict detection technique. NPL 1 describes therein that a check is made as to whether a passage condition such as airspace is met between a precedent aircraft and a subsequent aircraft in order of time. It describes therein that if the condition is not met, a passage time of an aircraft is delayed.

Further, PLT 1 describes therein a moving-body-abnormal-nearing monitor system. With the technique described in PLT 1, a lateral length is defined based on a lateral shift permitted width on the cruises of the aircrafts and a longitudinal length is defined based on the cruising time (20 minutes in the example described in PLT 1) thereby to define a separation box. If a bend point is present in a cruising time, the separation box is defined in consideration of the bend point. Then, the separation box is used to determine possible abnormal nearing between moving bodies.

### CITATION LIST

### Patent Literature

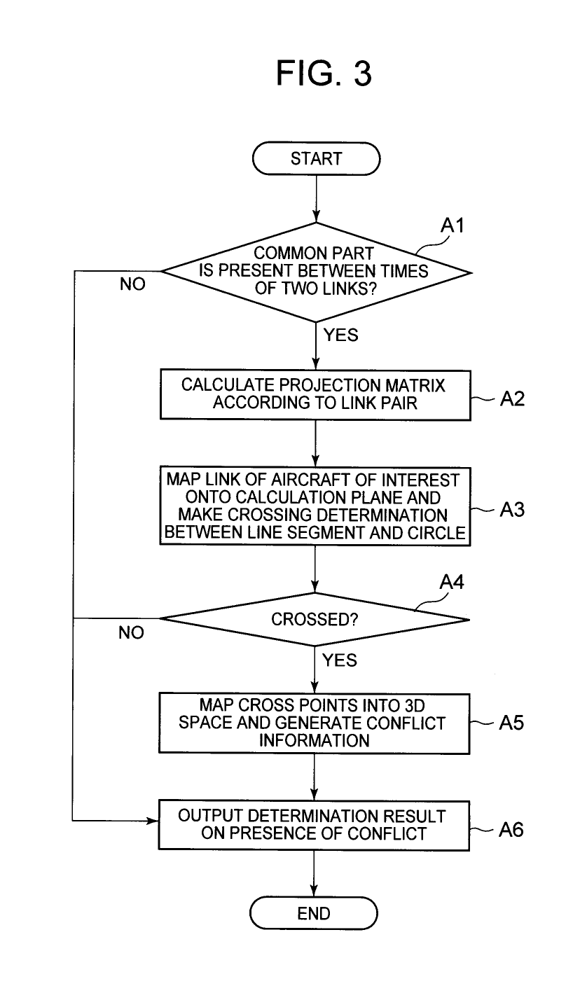

PLT 1: JP 5-307700 A (paragraph 0008, FIG. 3 and others)

### Non Patent Literature

NPL 1: FUKUDA Yutaka, OKA Megumi and YAMAMOTO Tetsushi, “Development of Assisting Tool for Time Management of Air Traffic Control”, IEICE Technical Report. SANE, The Institute of Electronics, Information and Communication Engineers, Jul. 18, 2008, Vol. 108, No. 169, pp. 23-28

### SUMMARY OF INVENTION

### Technical Problem

With the technique described in NPL 1, a check is made as to whether a passage condition such as airspace between aircrafts is met in order of time. In other words, presence of conflict is checked per time. That is, as many determinations as segments of the cruising time in temporal unit reflecting desired accuracy need to be repeated on presence of conflict. Thus, it takes a long time for processing of detecting an occurrence of conflict in the courses of the precedent aircraft and the subsequent aircraft. When an occurrence of conflict is detected, a passage time is corrected for one aircraft and then an occurrence of conflict may be detected again, but in this case, a longer processing time is required.

It is therefore an object of the present invention to provide a moving-body-abnormal-nearing detection system capable of determining whether abnormal nearing between moving bodies will occur in a short processing time, a moving-body-abnormal-nearing detection method therefor, and a moving-body-abnormal-nearing detection program therefor.

### Solution to Problem

A moving-body-abnormal-nearing detection system according to the present invention includes a projection matrix calculation means for calculating a first projection matrix indicating mapping from a 3D space onto a 2D plane based on period information of a first moving body having a 3D coordinate with the coordinate values of a 2D coordinate of a passage position of the first moving body and a passage time as information on the start point and the end point of the period and period information of a second moving body having a 3D coordinate with the coordinate values of a 2D coordinate of a passage position of the second moving body and a passage time as information on the start point and the end point of the period, and an abnormal nearing determination means for mapping the period information of the first moving body to a line segment in the 2D plane by use of the first projection matrix, and determining how a circle whose center is a passage position of the second moving body and whose radius is a threshold as a determination standard as to whether abnormal nearing will occur crosses with the line segment in the 2D plane, thereby determining whether abnormal nearing between the first moving body and the second moving body will occur.

A moving-body-abnormal-nearing detection method according to the present invention includes the steps of calculating a first projection matrix indicating mapping from a 3D space onto a 2D plane based on period information of a first moving body having a 3D coordinate with the coordinate values of a 2D coordinate of a passage position of the first moving body and a passage time as information on the start point and the end point of the period and period information of a second moving body having a 3D coordinate with the coordinate values of a 2D coordinate of a passage position of the second moving body and a passage time as information on the start point and the end point of the period, and mapping the period information of the first moving body to a line segment in the 2D plane by use of the first projection matrix, and determining how a circle whose center is a passage position of the second moving body and whose radius is a threshold as a determination standard as to whether abnormal nearing will occur crosses with the line segment in the 2D plane, thereby determining whether abnormal nearing between the first moving body and the second moving body will occur.

A moving-body-abnormal-nearing detection program according to the present invention includes causing a computer to perform projection matrix calculation processing of calculating a first projection matrix indicating mapping from a 3D space onto a 2D plane based on period information of a first moving body having a 3D coordinate with the coordinate values of a 2D coordinate of a passage position of the first moving body and a passage time as information on the start point and the end point of the period and period information of a second moving body having a 3D coordinate with the coordinate values of a 2D coordinate of a passage position of the second moving body and a passage time as information on the start point and the end point of the period, and abnormal nearing determination processing of mapping the period information of the first moving body to a line segment in the 2D plane by use of the first projection matrix, and determining how a circle whose center is a passage position of the second moving body and whose radius is a threshold as a determination standard as to whether abnormal nearing will occur crosses with the line segment in the 2D plane, thereby determining whether abnormal nearing between the first moving body and the second moving body will occur.

### Advantageous Effects of Invention

According to the present invention, it is possible to determine whether abnormal nearing between moving bodies will occur in a short processing time.

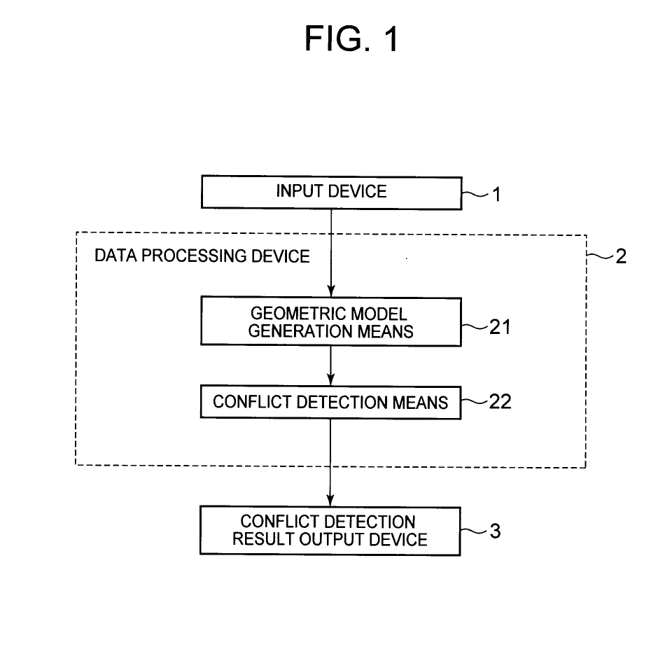

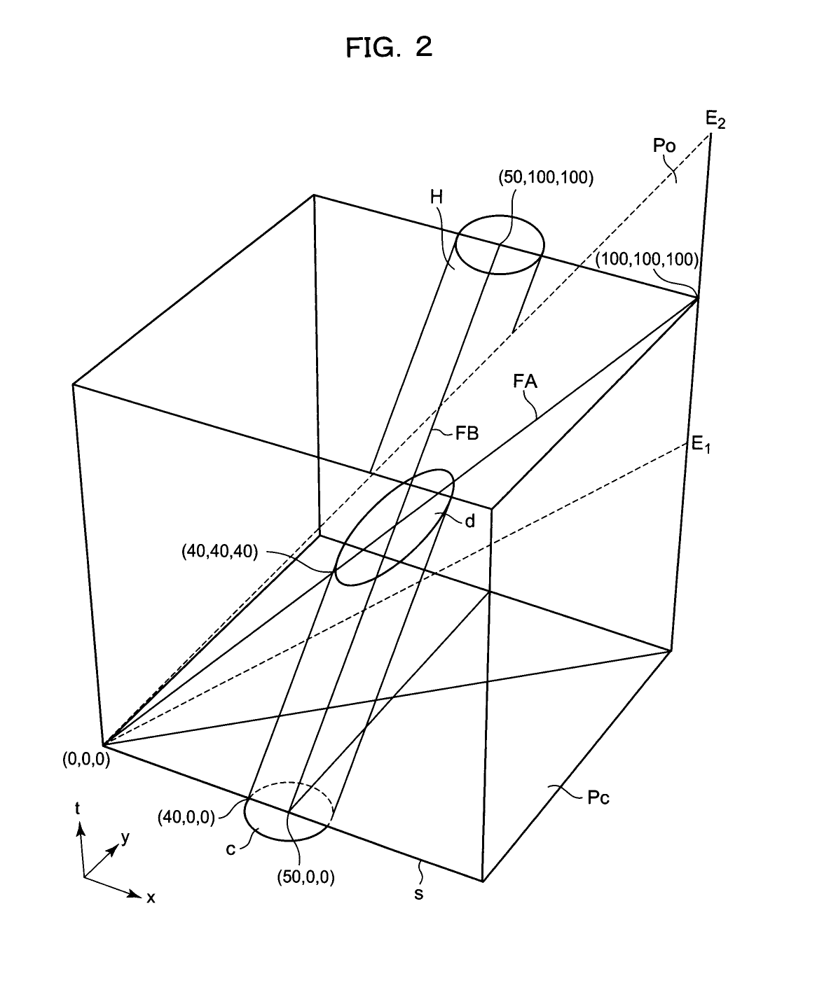

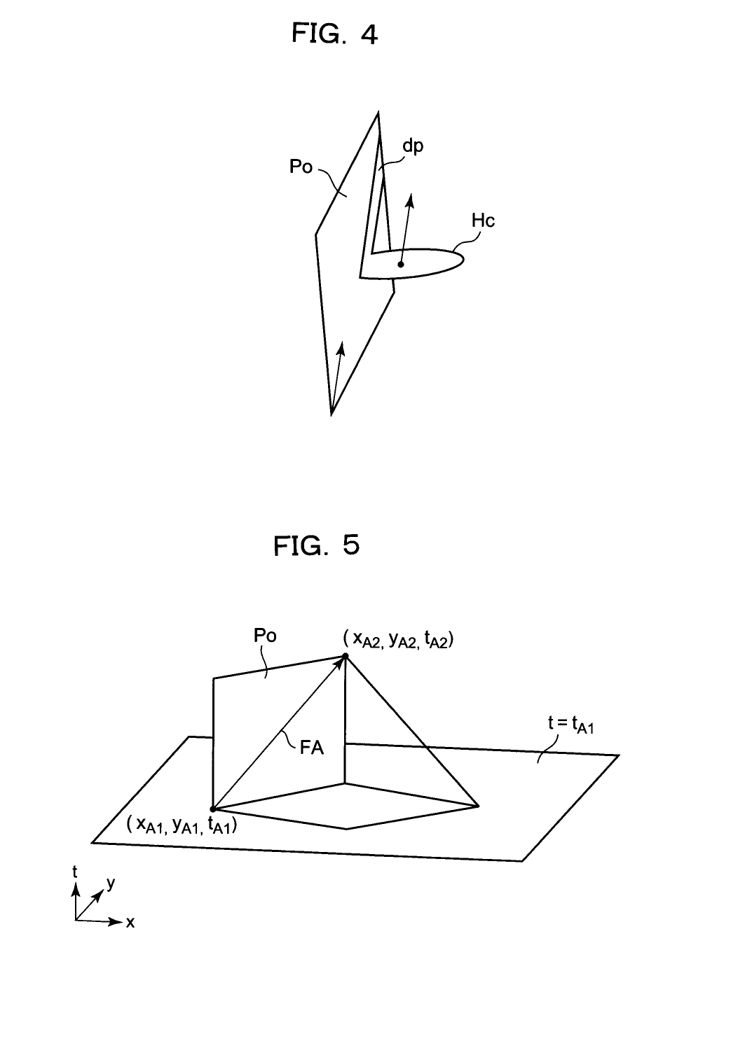

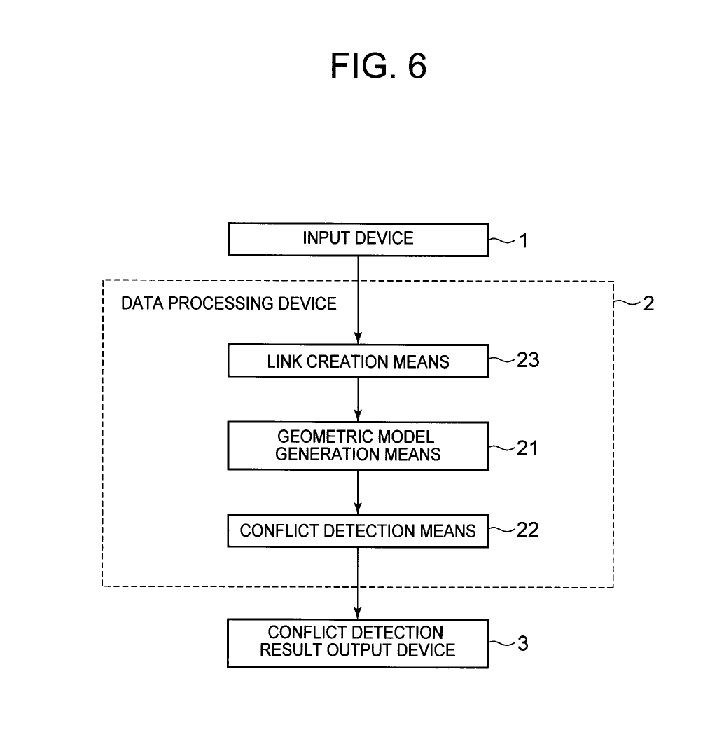

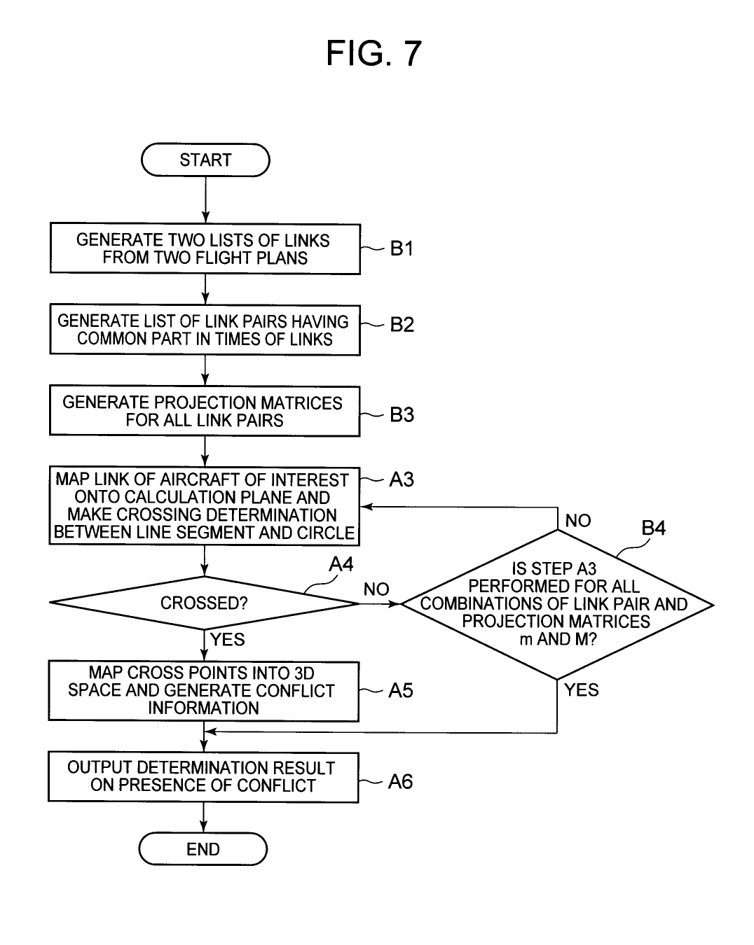

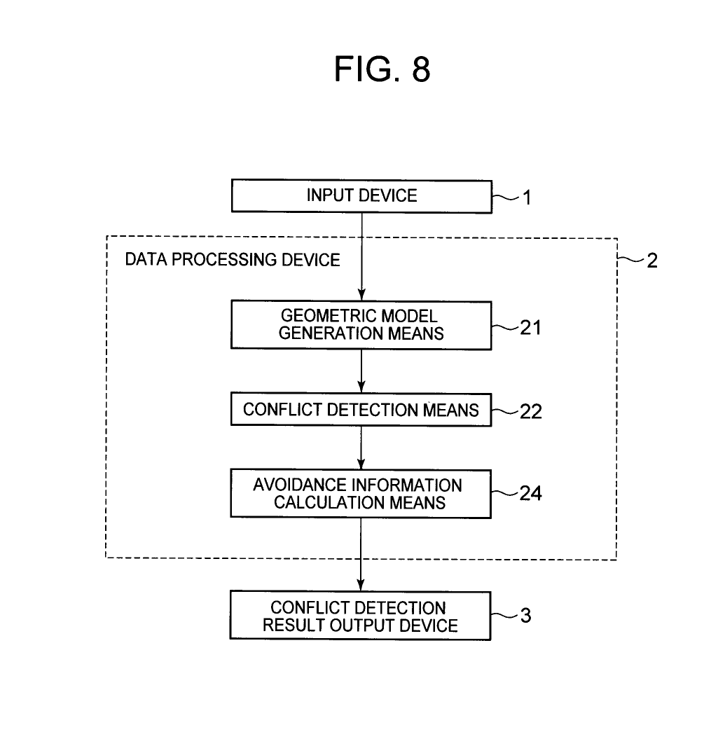

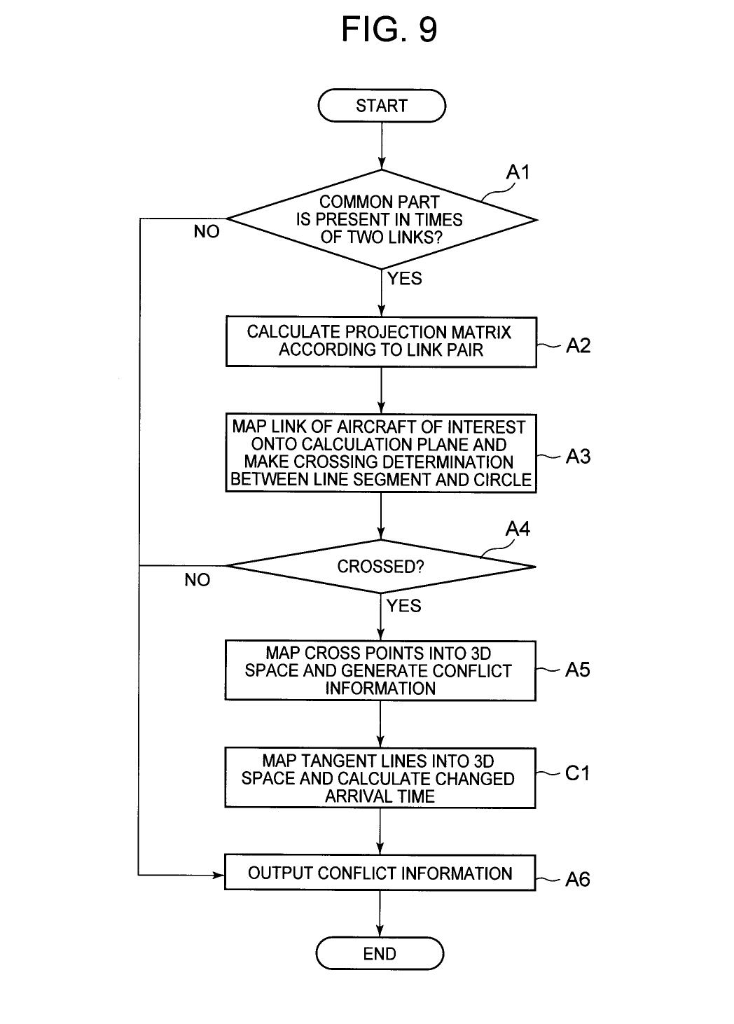

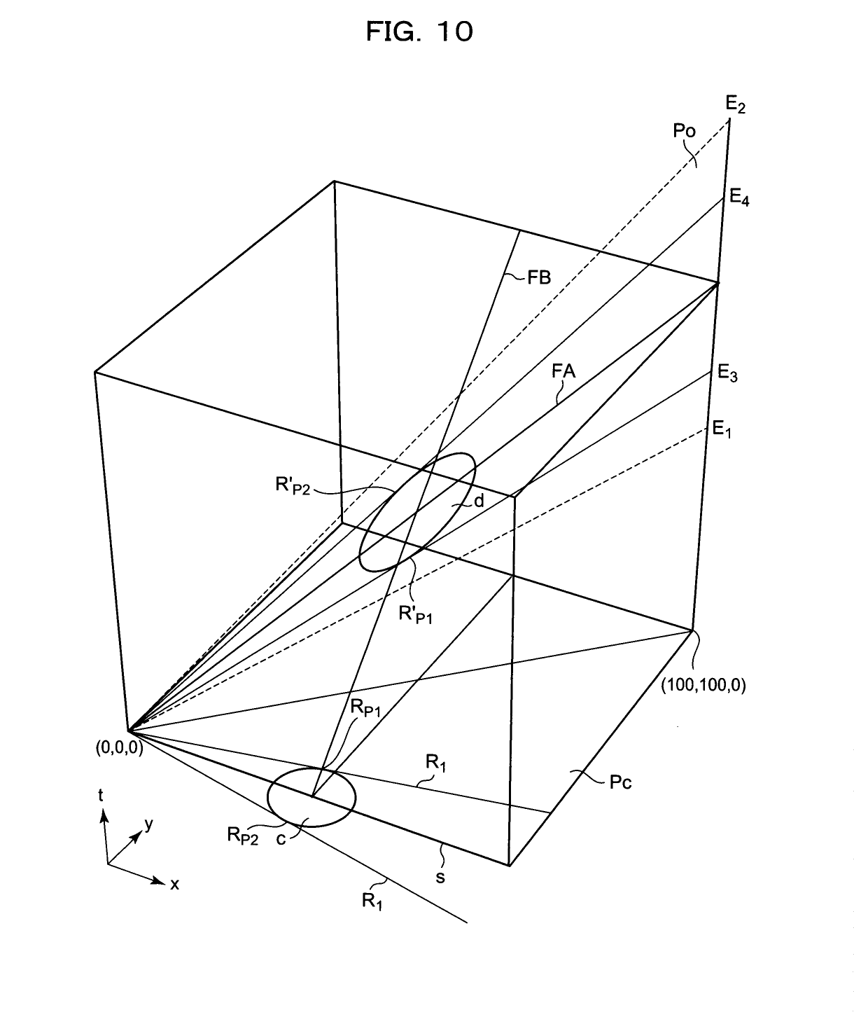

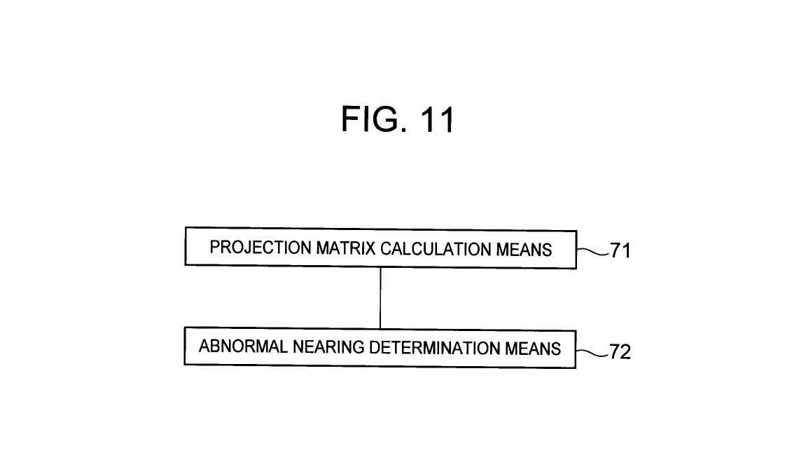

### BRIEF DESCRIPTION OF DRAWINGS

[FIG. 1] It depicts a block diagram illustrating an exemplary structure of a moving-body-abnormal-nearing detection system according to a first exemplary embodiment of the present invention.

[FIG. 2] It depicts an explanatory diagram illustrating a 3D space and a 2D plane at the start point time of a link.

[FIG. 3] It depicts a flowchart illustrating exemplary processing progress according to the first exemplary embodiment of the present invention.

[FIG. 4] It depicts a schematic diagram illustrating how a tilted column H defined from a link FB of a peripheral aircraft crosses with a plane Pₒ when the courses of an aircraft of interest and the peripheral aircraft are present on the same straight line or parallel with each other.

[FIG. 5] It depicts a schematic diagram illustrating an alternative straight line to a straight line formed by the peripheral aircraft.

[FIG. 6] It depicts a block diagram illustrating an exemplary structure of the moving-body-abnormal-nearing detection system according to a second exemplary embodiment of the present invention.

[FIG. 7] It depicts a flowchart illustrating exemplary processing progress according to the second exemplary embodiment of the present invention.

[FIG. 8] It depicts a block diagram illustrating an exemplary structure of the moving-body-abnormal-nearing detection system according to a third exemplary embodiment of the present invention.

[FIG. 9] It depicts a flowchart illustrating exemplary processing progress according to the third exemplary embodiment of the present invention.

[FIG. 10] It depicts an explanatory diagram schematically illustrating the processing in step C1.

[FIG. 11] It depicts a block diagram illustrating an exemplary minimum structure of the present invention.

### DESCRIPTION OF EMBODIMENTS

The exemplary embodiments according to the present invention will be described below with reference to the drawings. Each exemplary embodiment indicated below will be described by way of a case in which abnormal nearing (conflict) between aircrafts is detected, but the present invention may be applied to detect abnormal nearing between moving bodies other than aircrafts.

### First Exemplary Embodiment

FIG. 1 is a block diagram illustrating an exemplary structure of a moving-body-abnormal-nearing detection system according to a first exemplary embodiment of the present invention. The moving-body-abnormal-nearing detection system according to the present exemplary embodiment includes an input device 1, a data processing device 2, and a conflict detection result output device 3. Further, the data processing device 2 includes a geometric model generation means 21 and a conflict detection means 22.

In the following description, one of two aircrafts, for which presence of conflict is to be determined, is denoted as aircraft of interest and the other thereof is denoted as peripheral aircraft. The flight plans are defined for the aircraft of interest and the peripheral aircraft, respectively. The flight plan is an aircraft movement plan. The flight plan indicates an aircraft movement plan by a set of lists of coordinates of passage points and their passage times of an aircraft. The coordinate of each passage point is indicated by an x coordinate and a y coordinate in a 2D plane. For example, the x coordinate indicates latitude and the y coordinate indicates longitude. In the following description, the x coordinate and the y coordinate will be indicated by simple values for simplified description. In the flight plan of one aircraft, a period defined by one pair of passage points adjacent in order of passage time will be denoted as link below. The flight plan indicates a set of links, and a start point coordinate and its passage time as well as an end point coordinate and its passage time of each link are defined in the flight plan. The moving-body-abnormal-nearing detection system according to the present exemplary embodiment determines whether a conflict will occur between the aircraft of interest and the peripheral aircraft based on one link selected from the flight plan of the aircraft of interest and one link selected from the flight plan of the peripheral aircraft.

It is assumed that the aircraft of interest and the peripheral aircraft conduct uniform linear motion in each link defined by the flight plans, respectively.

The input device 1 is an input interface of input data in processing of determining presence of conflict. In the present exemplary embodiment, the input device 1 is input with one link of the aircraft of interest, one link of the peripheral aircraft, and safe distance information. In the following, a pair of one link of the aircraft of interest and one link of the peripheral aircraft may be denoted as link pair. The safe distance information indicates a distance threshold which is a determination standard as to whether abnormal nearing between moving bodies will occur. The following description will be made by way of a case in which an oceanic airspace is input as safe distance information.

The information on the start points and the end points of the respective links of the aircraft of interest and the peripheral aircraft include information on positional coordinates (x coordinate, y coordinate) in the 2D plane and times. Thus, the information on the start point and the end point of each link can indicate a point in the 3D space where a temporal axis as the third axis is added to the x coordinate and the y coordinate in the 2D plane.

The geometric model generation means 21 determines whether a common part is present between the time from the start point time to the end point time of the link of the aircraft of interest and the time from the start point time to the end point time of the link of the peripheral aircraft in the input link pair, and if a common time zone is present, calculates a projection matrix indicating mapping from the 3D space defined by the x axis, the y axis and the temporal axis (which will be denoted as t axis below) (which will be simply denoted as 3D space below) onto the 2D plane and a projection matrix indicating its inverse mapping (from the 2D plane into the 3D space). The 2D plane is at the later time out of the start point times of the two links making the link pair. The following description will be made by way of a case in which the start point times of the two links making the link pair are common and the end point times are also common for simplified description.

FIG. 2 is an explanatory diagram illustrating a 3D space and a 2D plane at the start point time of a link. It is assumed that the start point and the end point of a link are indicated by the 3D coordinates (x coordinate, y coordinate, t coordinate), and one like is indicated in a form of [(x coordinate of start point, y coordinate of start point, t coordinate of start point), (x coordinate of end point, y coordinate of end point, t coordinate of end point)].

In the example illustrated in FIG. 2, the link FA is a link of the aircraft of interest. The link FB is a link of the peripheral aircraft. FA=[(0, 0, 0), (100, 100, 100)] and FB=[(50, 0, 0), (50, 100, 100)] are assumed herein. The start point times of the two links are common at t=0. Thus, the later time out of the start point times of the two links may be t=0. In the present example, the geometric model generation means 21 calculates a projection matrix indicating mapping from the 3D space onto the 2D plane at t=0, and a projection matrix indicating its inverse mapping. The 2D plane as a destination of the mapping from the 3D space will be denoted as calculation plane below. Mapping from the 3D space onto the calculation plane is along the link FB of the peripheral aircraft.

The geometric model generation means 21 may define either one of the input link pair as the link of the aircraft of interest and may define the other thereof as the link of the peripheral aircraft. Presence of conflict between two aircrafts is determined in the first exemplary embodiment and the second exemplary embodiment, but when a conflict occurs, information for avoiding the conflict (avoidance information in a third exemplary embodiment described later) is not calculated. In this case, the geometric model generation means 21 may define any of the two links as the link of the aircraft of interest. Then, the conflict detection means 21 performs the processing assuming one link as the link of the aircraft of interest and the other link as the link of the peripheral aircraft as defined by the geometric model generation means 21.

Alternatively, aircraft-of-interest designation information indicating which link is of the aircraft of interest is input into the input device 1, and the geometric model generation means 21 may define the link designated by the aircraft-of-interest designation information as the link of the aircraft of interest and the other link as the link of the peripheral aircraft.

In the example illustrated in FIG. 2, when the speed of the aircraft of interest is accelerated, the end point time of the link FA is put ahead, and when the speed of the aircraft of interest is decelerated, the end point time of the link FA is also delayed. For example, the point E₁ indicated in FIG. 2 indicates an exemplary end point of the link when the speed of the aircraft of interest is accelerated, and the point E₂ indicates an exemplary end point of the link when the speed of the aircraft of interest is decelerated. In this way, the speed of the aircraft of interest is changed thereby to define a plane (plane including the points (0, 0, 0), E₁, and E₂ in the example illustrated in FIG. 2). The plane will be denoted as P₀ below.

There is assumed a state in which a circle whose center is a point on the link FB and whose radius is an oceanic airspace is defined per point on the link FB of the peripheral aircraft. This circle is assumed to be parallel with the calculation plane P_{c}. Then, as illustrated in FIG. 2, the tilted column H with the circular bottom is defined.

Crossing between the plane P₀ and the tilted column H is indicated by an oval d as illustrated in FIG. 2. Crossing between the oval d and the link FA of the aircraft of interest in the 3D space means that a conflict will occur, and no crossing means that a conflict will not occur. In the present invention, however, crossing between the oval d and the link FA of the aircraft of interest in the 3D space is not determined, but presence of conflict is determined by use of a line segment obtained by mapping the link FA onto the calculation plane P_{c}.

The conflict detection means 22 is input with the oceanic airspace by the input device 1. Further, it is input with a link pair and two projection matrices from the geometric model generation means 21.

The conflict detection means 22 maps the link of the aircraft of interest onto the calculation plane P_{c} by use of the projection matrix from the 3D space onto the calculation plane P_{c}. Then, the conflict detection means 22 determines whether a conflict will occur between the aircraft of interest and the peripheral aircraft by use of the circle (denoted as c) within the calculation plane P_{c} whose center is the start point of the link of the peripheral aircraft and whose radius is the oceanic airspace and the line segment (denoted as s) obtained by mapping the link of the aircraft of interest. In the example illustrated in FIG. 2, the line segment s obtained by mapping the link FA is along the x axis. When the circle c crosses with the line segment s, the conflict detection means 22 determines that a conflict will occur, and when they do not cross with each other, determines that a conflict will not occur. The circle c is the mapped oval d (see FIG. 2) onto the calculation plane P_{c}, but may be defined from the information on the start point of the link of the peripheral aircraft and the oceanic airspace without finding the oval d. Mapping from the 3D space onto the calculation plane P_{c} does not need to be calculated in order to specify the circle c.

When determining that a conflict has occurred, the conflict detection means 22 calculates an occurrence time and an occurrence place of the conflict by use of the projection matrix indicating the mapping from the calculation plane P_{c} into the 3D space.

The conflict detection result output device 3 outputs the determination result on presence of conflict by the conflict detection means 22. When an occurrence time and an occurrence place of the conflict are calculated, the information on the occurrence time and the occurrence place is also output.

The geometric model generation means 21 and the conflict detection means 22 are realized by the CPU in a computer operating according to a moving-body-abnormal-nearing detection program, for example. For example, the CPU reads the moving-body-abnormal-nearing detection program from a computer readable recording medium recording the moving-body-abnormal-nearing detection program therein, and may operate as the geometric model generation means 21 and the conflict detection means 22 according to the program. The geometric model generation means 21 and the conflict detection means 22 may be realized in separate hardware.

A processing progress according to the first exemplary embodiment will be described below. FIG. 3 is a flowchart illustrating exemplary processing progress according to the first exemplary embodiment of the present invention. The input device 1 is input with a link pair including a link extracted from the flight plan of the aircraft of interest and a link extracted from the flight plan of the peripheral aircraft, and the oceanic airspace from the manager of the moving-body-abnormal-nearing detection system. The input device 1 sends the link pair to the geometric model generation means 21 and sends the oceanic airspace to the conflict detection means 22.

The geometric model generation means 21 determines whether a common part is present between the time from the start point time to the end point time of one link in the link pair and the time from the start point time to the end point time of the other link (step A1).

When a common part is not present between the times of the two links (NO in step A1), the geometric model generation means 21 sends the determination result that a conflict will not occur to the conflict detection result output device 3, and the conflict detection result output device 3 outputs the determination result (step A6).

When a common part is present between the times of the two links (YES in step A1), the geometric model generation means 21 calculates a projection matrix (denoted as m) indicating mapping from the 3D space onto the calculation plane P_{c} and a projection matrix (denoted as M) indicating its inverse mapping based on the link of the aircraft of interest and the link of the peripheral aircraft. The geometric model generation means 21 then inputs the link pair and the projection matrices m and M into the conflict detection means 22 (step A2). Exemplary calculations of the projection matrices will be described later.

After step A2, the conflict detection means 22 maps the link of the aircraft of interest indicated in the 3D space onto the calculation plane P_{c} by use of the projection matrix m, and calculates a line segment s as a mapping result of the link of the aircraft of interest. The conflict detection means 22 then determines how the circle c in the calculation plane P_{c} whose center is the start point of the link of the peripheral aircraft and whose radius is the oceanic airspace crosses with the line segment s (step A3).

Crossing between the circle c and the line segment s means that a conflict will occur between the aircraft of interest and the peripheral aircraft. No crossing between the circle c and the line segment s means that a conflict will not occur between the aircraft of interest and the peripheral aircraft.

As a result of the crossing determination in step A3, when determining that the circle c does not cross with the line segment s (NO in step A4), the conflict detection means 22 sends the determination result that a conflict will not occur to the conflict detection result output device 3, and the conflict detection result output device 3 outputs the determination result (step A6).

As a result of the crossing determination in step A3, when determining that the circle c crosses with the line segment s (YES in step A4), the conflict detection means 22 maps the cross points between the circle c and the line segment s into the 3D space by use of the projection matrix M thereby to generate conflict information (information on an occurrence time and an occurrence place of the conflict) (step A5).

After step A5, the conflict detection means 22 sends the determination result that a conflict will occur and the conflict information to the conflict detection result output device 3, and the conflict detection result output device 3 outputs the determination result and the conflict information (step A6).

The operations of the present exemplary embodiment will be described below by way of a specific example. The following specific example assumes that the course of the aircraft of interest and the course of the peripheral aircraft are neither on the same straight line nor parallel with each other.

The following description assumes that an oceanic airspace of 10 is input into the input device 1. Further, it assumes that FA=[(0, 0, 0), (100, 100, 100)] indicated in FIG. 2 is input as the link FA of the aircraft of interest and FB=[(50, 0, 0), (50, 100, 100)] indicated in FIG. 2 is input as the link FB of the peripheral aircraft.

In the present example, the start point times of the two links are common at t=0 and the later time out of the start point times of the two links is t=0. Thus, the calculation plane P_{c} is at t=0.

The time from the start point time to the end point time is between t=0 and t=100 in any of the links FA and FB. Thus, the geometric model generation means 21 determines that a common part is present between the time from the start point time to the end point time of the link FA and the time from the start point time to the end point time of the link FB (YES in step A1).

The geometric model generation means 21 then calculates the projection matrix m indicating mapping from the 3D space onto the calculation plane P_{c} and the projection matrix M indicating its inverse mapping (mapping from the calculation plane P_{c} into the 3D space) by use of the link FA of the aircraft of interest and the link FB of the peripheral aircraft.

The link FA is generally denoted as FA=[(x_{A1}, y_{A1}, t_{A1}), (x_{A2}, y_{A2}, t_{A2})]. That is, the x coordinate at the start point of the link FA is denoted as x_{A1}, the y coordinate is denoted as y_{A1}, and the time when the aircraft of interest passes through the position is denoted as t_{A1}. The x coordinate at the end point of the link FA is denoted as x_{A2}, the y coordinate is denoted as y_{A2}, and the time when the aircraft of interest passes through the position is denoted as t_{A2}.

Similarly, the link FB is generally denoted as FB=[(x_{P1}, y_{B1}, t_{B1}), (x_{P2}, y_{B2}, t_{B2})]. That is, the x coordinate at the start point of the link FB is denoted as x_{B1}, the y coordinate is denoted as y_{B1}, and the time when the peripheral aircraft passes through the position is denoted as t_{B1}. The x coordinate at the end point of the link FB is denoted as x_{B2}, the y coordinate is denoted as y_{B2}, and the time when the peripheral aircraft passes through the position is denoted as t_{B2}.

When the course of the aircraft of interest and the course of the peripheral aircraft are neither on the same straight line nor parallel with each other, the geometric model generation means 21 can find the projection matrix M indicating mapping from the calculation plane into the 3D space and the projection matrix m indicating mapping from the 3D space onto the calculation plane P_{c} by calculating the following Equation (1) and Equation (2), respectively.

$$\begin{matrix}[ Mathematical formula 1 ] & \\ M = ( \begin{matrix}1 - \frac{{( {y}_{A 2} - {y}_{A 1} )}^{2}}{\begin{matrix}{( {x}_{A 2} - {x}_{A 1} )}^{2} + \\ {( {y}_{A 2} - {y}_{A 1} )}^{2}\end{matrix}} & \frac{\begin{matrix}( {x}_{A 2} - {x}_{A 1} ) \\ ( {y}_{A 2} - {y}_{A 1} )\end{matrix}}{\begin{matrix}{( {x}_{A 2} - {x}_{A 1} )}^{2} + \\ {( {y}_{A 2} - {y}_{A 1} )}^{2}\end{matrix}} & 0 - \frac{{( {y}_{A 2} - {y}_{A 1} )}^{2}}{\begin{matrix}{( {x}_{A 2} - {x}_{A 1} )}^{2} + \\ {( {y}_{A 2} - {y}_{A 1} )}^{2}\end{matrix}} \vert \begin{matrix}{x}_{A 2} - {x}_{A 1} & {y}_{A 2} - {y}_{A 1} \\ {x}_{A 1} & {y}_{A 1}\end{matrix} \vert \\ \frac{( {y}_{A 2} - {y}_{A 1} ) ( {x}_{A 2} - {x}_{A 1} )}{\begin{matrix}{( {x}_{A 2} - {x}_{A 1} )}^{2} + \\ {( {y}_{A 2} - {y}_{A 1} )}^{2}\end{matrix}} & 1 - \frac{{( {x}_{A 2} - {x}_{A 1} )}^{2}}{\begin{matrix}{( {x}_{A 2} - {x}_{A 1} )}^{2} + \\ {( {y}_{A 2} - {y}_{A 1} )}^{2}\end{matrix}} & 0 \frac{{( {x}_{A 2} - {x}_{A 1} )}^{2}}{\begin{matrix}{( {x}_{A 2} - {x}_{A 1} )}^{2} + \\ {( {y}_{A 2} - {y}_{A 1} )}^{2}\end{matrix}} \vert \begin{matrix}{x}_{A 2} - {x}_{A 1} & {y}_{A 2} - {y}_{A 1} \\ {x}_{A 1} & {y}_{A 1}\end{matrix} \vert \\ \frac{\begin{matrix}( {t}_{A 2} - {t}_{A 1} ) \\ ( {y}_{A 2} - {y}_{A 1} )\end{matrix}}{\begin{matrix}{( {x}_{A 2} - {x}_{A 1} )}^{2} + \\ {( {y}_{A 2} - {y}_{A 1} )}^{2}\end{matrix}} & - \frac{\begin{matrix}( {t}_{A 2} - {t}_{A 1} ) \\ ( {x}_{A 2} - {x}_{A 1} )\end{matrix}}{\begin{matrix}{( {x}_{A 2} - {x}_{A 1} )}^{2} + \\ {( {y}_{A 2} - {y}_{A 1} )}^{2}\end{matrix}} & 0 \frac{( {t}_{A 2} - {t}_{A 1} )}{\begin{matrix}{( {x}_{A 2} - {x}_{A 1} )}^{2} + \\ {( {y}_{A 2} - {y}_{A 1} )}^{2}\end{matrix}} \vert \begin{matrix}{x}_{A 2} - {x}_{A 1} & {y}_{A 2} - {y}_{A 1} \\ {x}_{A 1} & {y}_{A 1}\end{matrix} \vert\end{matrix} ) & Equation ( 1 ) \\ [ Mathematical formula 2 ] & \\ m = ( \begin{matrix}1 & 0 & \frac{{y}_{A 2} - {y}_{A 1}}{{t}_{A 2} - {t}_{A 1}} & - \frac{{y}_{A 2} - {y}_{A 1}}{{t}_{A 2} - {t}_{A 1}} {t}_{A 1} \\ 0 & 1 & - \frac{{x}_{A 2} - {x}_{A 1}}{{t}_{A 2} - {t}_{A 1}} & \frac{{x}_{A 2} - {x}_{A 1}}{{t}_{A 2} - {t}_{A 1}} {t}_{A 1} \\ 0 & 0 & 0 & {t}_{A 1}\end{matrix} ) & Equation ( 2 )\end{matrix}$$

The geometric model generation means 21 then inputs the links FA and FB and the projection matrices m and M into the conflict detection means 22 (step A2).

The conflict detection means 22 uses only the first row and the second row in the projection matrix m and thus the geometric model generation means 21 may input the links FA and FB, the first row and the second row in the projection matrix m, and the projection matrix M into the conflict detection means 22.

When the first row in the projection matrix M is assumed as M1, the second row therein is assumed as M2 and the third row therein is assumed as M3, the projection matrix M with M1=(1, 0, 0, 0), M2=(1, 0, 0, 0) and M3=(1, −1, 1, 0) can be found from the FA=[(0, 0, 0), (100, 100, 100)] and FB=[(50, 0, 0), (50, 100, 100)]. When the first row in the projection matrix m is assumed as m1 and the second row therein is assumed as m2, m1=(1, 0, 0, 0) and m2=(0, 1, −1, 0) are assumed.

In step A3, the conflict detection means 22 maps the link FA onto the calculation plane P_{c} by use of the projection matrix m thereby to calculate a line segment s. Specifically, the conflict detection means 22 calculates the start point and the end point of the line segment s. The conflict detection means 22 assumes (x_{A1}, y_{A1}) as the start point of the line segment s. The conflict detection means 22 assumes the end point of the line segment s at the point with the x coordinate which is an inner product of (x_{A2}, y_{A2}, 0, 1) and m1 (the first row in the projection matrix m) and the y coordinate which is an inner product of (x_{A2}, y_{A2}, t_{A2}, 1) and m2 (the second row in the projection matrix m). In the present example, the line segment s (see FIG. 2) with the start point (0, 0) and the end point (100, 0) is found based on FA=[(0, 0, 0), (100, 100, 100)], m1==(1, 0, 0, 0) and m2=(0, 1, −1, 0).

The circle c used for the crossing determination in step A3 has the center (x_{B1}, y_{B1}) and the radius which is the oceanic airspace. In the present example, the conflict detection means 22 specifies the circle c (see FIG. 2) with the center (50, 0) and the radius of 10 based on FB=[(50, 0, 0), (50, 100, 100)] and the oceanic airspace of “10.”

The conflict detection means 22 determines how the line segment s and the circle c as defined above cross with each other (step A3). When determining that the circle c does not cross with the line segment s (NO in step A4), the conflict detection means 22 sends the determination result that a conflict will not occur to the conflict detection result output device 3, and the conflict detection result output device 3 outputs the determination result (step A6).

In the present example, the line segment s crosses with the circle c as illustrated in FIG. 2 (YES in step A4). In this case, the conflict detection means 22 calculates the cross points between the line segment s and the circle c. When the line segment s crosses with the circle c at two points, the conflict detection means 22 calculates the cross point closer to the start point of the line segment s out of the cross points between the line segment s and the circle c. The coordinate of the cross point is denoted as (x_{c}, y_{c}). The conflict detection means 22 defines a vector (x_{c}, y_{c}, t_{A1}, 1). The vector is assumed as p. Further, the conflict detection means 22 calculates the inner product p·M1 of p=(x_{c}, y_{c}, t_{A1}, 1) and M1, the inner product p·M2 of the vector p and M2, and the inner product p·M3 of the vector p and M3 thereby to find an occurrence place of the conflict and an occurrence time of the conflict (step A5). The point (p·M1, p·M2) with the x coordinate of p·M1 and the y coordinate of p·M2 is the occurrence place of the conflict. p·M3 is the occurrence time of the conflict.

The cross point (the cross point closer to the line segment s) (40, 0) between the line segment s with the start point (0, 0) and the end point (100, 0) and the circle c with the center (50, 0) and the radius of 10 is obtained. When the vector p is defined by use of the coordinates of the cross point and t_{A1} (the time at the start point of the link FA) thereby to calculate the occurrence place (p·M1, p·M2) of the conflict and the occurrence time p·M3 of the conflict, the coordinate of the occurrence place of the conflict is calculated as (40, 40) and the occurrence time of the conflict is calculated as 40. The calculations for finding the occurrence place of the conflict and the occurrence time of the conflict by calculating p·M1, p·M2, and p·M3 is the processing of mapping the cross point (40, 0) to the coordinate (40, 40, 40) in the 3D space (see FIG. 2).

After step A5, the conflict detection means 22 sends the determination result that a conflict will occur, and the information on the occurrence place and the occurrence time of the conflict to the conflict detection result output device 3, and the conflict detection result output device 3 outputs the determination result and the information on the occurrence place and the occurrence time of the conflict (step A6).

As described above, the circle c corresponds to the mapped oval d (crossing between the tilted column defined by the link FB of the peripheral aircraft and the plane P₀) onto the calculation plane. In the present exemplary embodiment, presence of conflict is determined by determining how the line segment s which is the mapped link FA of the aircraft of interest onto the calculation plane crosses with the circle c. Thus, the processing of calculating a distance between the aircraft of interest and the peripheral aircraft per time does not need to be performed, and thus the processing of determining presence of conflict can be realized in a shorter processing time. Mapping from the 3D space onto the calculation plane or mapping from the calculation plane into the 3D space can be performed by simple matrix calculations, and thus an increase in processing time can be prevented.

In the present exemplary embodiment, a determination is made as to how the line segment s crosses with the circle c within the calculation plane P_{c}. Thus, the amount of calculations required for determining the crossing can be further reduced than a determination is made as to how the oval d crosses with the link FA in the 3D space, thereby reducing a time to determine presence of conflict.

As compared with the invention described in PLT 1, possible abnormal nearing between moving bodies is determined based on the separation box whose longitudinal length is defined based on the flight time according to the invention described in PLT 1. Thus, possible abnormal nearing within the flight time can be determined, but it is difficult to determine when and where the conflict will occur.

To the contrary, according to the present invention, the cross points between the line segment s and the circle c are mapped into the 3D space thereby to specify an occurrence place and an occurrence time of the conflict. That is, more detailed conflict information can be obtained according to the present invention.

A variant of the first exemplary embodiment will be described below.

According to the first exemplary embodiment, the conflict detection means 22 may not generate information on an occurrence place and an occurrence time of a conflict. In this case, the geometric model generation means 21 may calculate only the projection matrix m and may not calculate the projection matrix M. The conflict detection means 22 then determines how the line segment s crosses with the circle c, and when determining that they cross with each other (YES in step A4), may not perform the processing in step A5. The conflict detection means 22 then sends the determination result that a conflict will occur to the conflict detection result output device 3, and the conflict detection result output device 3 may output the determination result.

The above exemplary embodiment has been described by way of the case in which the start point time of a link of the aircraft of interest is common with the start point time of a link of the peripheral aircraft. When the start point times of the two links are different, the start point coordinate (x, y, t) of the link at the earlier start point time may be updated such that the start point time is the same as the start point time of the other link. For example, it is assumed that FA=[(x_{A1}, y_{A1}, t_{A1}), (x_{A2}, y_{A2}, t_{A2})] and FB=[(x_{B1}, y_{B1}, t_{B1}), (x_{B2}, y_{B2}, t_{B2})] are given. When t_{A1} is earlier than t_{B1}, the start point of the link FA may be updated at the cross point coordinate between the link FA and the calculation plane (t=t_{B1}). When t_{B1} is earlier than t_{A1}, the start point of the link FB may be updated at the cross point coordinate between the link FB and the calculation plane (t=t_{A1}). After such update, the similar operations to the above exemplary embodiment may be performed.

The above exemplary embodiment has described the case in which the course of the aircraft of interest and the course of the peripheral aircraft are neither on the same straight line nor parallel with each other. The projection matrices will be described when the course of the aircraft of interest and the course of the peripheral aircraft are on the same straight line or parallel with each other. FIG. 4 is a schematic diagram illustrating how the tilted column H defined by the link FB of the peripheral aircraft crosses with the plane Pₒ when the courses of the aircraft of interest and the peripheral aircraft are on the same straight line or parallel with each other. FIG. 4 illustrates the circle H_{c} which is a cross section of the tilted column H. As illustrated in FIG. 4, in this case, the crossing between the tilted column H and the plane Pₒ is not an oval but a parallelogram dₚ. A link of the aircraft of interest is assumed as FA=[(x_{A1}, y_{A1}, t_{A1}), (x_{A2}, t_{A2}, t_{A2})].

In this case, an arbitrary straight line passing through a point (x_{A2}, y_{A2}, t_{A2}) and crossing with the calculation plane may be used in place of a straight line formed by the peripheral aircraft. Herein, a straight line expressed in the following Equation (3) is assumed to be used.

(y_{A2}−y_{A1})x+(−x_{A2}+x_{A1})y+x_{A2}y_{A1}−x_{A1}y_{A2}=0 Equation (3)

The straight line passes through the point (x_{A2}, y_{A2}, t_{A2}) and forms 45° with the plane at t=t_{A1} as illustrated in FIG. 5.

In this case, the geometric model generation means 21 may calculate a matrix defined by the following Equation (4) as the projection matrix M indicating mapping from the calculation plane into the 3D space.

$$\begin{matrix}[ Mathematical formula 3 ] & \\ M = ( \begin{matrix}1 - {c}_{1} {y}_{A} & 0 + {c}_{1} {x}_{A} & 0 & - {c}_{1} {D}_{2} \\ 0 + {c}_{2} {y}_{A} & 1 - {c}_{2} {x}_{A} & 0 & {c}_{2} {D}_{2} \\ 0 + {c}_{3} {y}_{A} & 0 - {c}_{3} {x}_{A} & 1 & {c}_{3} {D}_{2}\end{matrix} ) & Equation ( 4 )\end{matrix}$$

D₂ is found by calculating the following Equation (5).

$$\begin{matrix}[ Mathematical formula 4 ] & \\ {D}_{2} = \vert \begin{matrix}{x}_{A} & {y}_{A} \\ {x}_{A 1} & {y}_{A 1}\end{matrix} \vert & Equation ( 5 )\end{matrix}$$

c₁, c₂ and c₃ are found by calculating the following Equation (6) to Equation (8), respectively.

c₁=y_{A}/D₁ Equation (6)

c₂=x_{A}/D₁ Equation (7)

c₃=t_{A}/D₁ Equation (8)

D₁, x_{A}, y_{A} and t_{A} are found by calculating the following Equation (9) to Equation (12), respectively.

D₁=x_{A}²+y_{A}² Equation (9)

x_{A}=x_{A2}−x_{A1} Equation (10)

y_{A}=y_{A2}−y_{A1} Equation (11)

t_{A}=t_{A2}−t_{A1} Equation (12)

The geometric model generation means 21 may calculate a matrix defined by the following Equation (13) as the projection matrix m indicating mapping from the 3D space onto the calculation plane.

$$\begin{matrix}[ Mathematical formula 5 ] & \\ m = ( \begin{matrix}1 & 0 & {c}_{4} & - {c}_{4} {t}_{A 1} \\ 0 & 1 & {c}_{5} & - {c}_{5} {t}_{A 1} \\ 0 & 0 & 0 & {t}_{A 1}\end{matrix} ) & Equation ( 13 )\end{matrix}$$

c4 and c5 are found by calculating the following Equation (14) and Equation (15), respectively.

c₄=y_{A}/t_{A} Equation (14)

c₅=−x_{A}/t_{A} Equation (15)

x_{A} and y_{A} are found by calculating the aforementioned Equation (10) and Equation (11), respectively.

When the courses of the aircraft of interest and the peripheral aircraft are on the same straight line or parallel with each other, the geometric model generation means 21 calculates the projection matrices M and m found by Equation (4) and Equation (13), for example. Other points are the same as those in the first exemplary embodiment.

### Second Exemplary Embodiment

FIG. 6 is a block diagram illustrating an exemplary structure of the moving-body-abnormal-nearing detection system according to a second exemplary embodiment of the present invention. The same components as the components according to the first exemplary embodiment are denoted with the same reference numerals in FIG. 1, and a detailed description thereof will be omitted. In the second exemplary embodiment, the data processing device 2 includes the geometric model generation means 21, the conflict detection means 22 and a link generation means 23.

In the present exemplary embodiment, the input device 1 is input with the flight plan of the aircraft of interest and the flight plan of the peripheral aircraft as well as safe distance information. Also in the second exemplary embodiment, there will be assumed a case in which an oceanic airspace is input as safe distance information.

The link creation means 23 creates a list of links of the aircraft of interest and a list of links of the peripheral aircraft from the flight plans of the aircraft of interest and the peripheral aircraft input via the input device 1. For example, the link creation means 23 arranges the 3D coordinates each having the coordinate values of the coordinates of a passage point and its passage time in ascending order of passage time in the flight plan of the aircraft of interest. The link creation means 23 then assumes a pair of adjacent 3D coordinates as one link and assumes a list of such links as a list of links of the aircraft of interest. Further, the link creation means 23 similarly creates a list of links of the peripheral aircraft from the flight plan of the peripheral aircraft.

Similarly as in the first exemplary embodiment, an individual link is expressed in a form of [(x coordinate of start point, y coordinate of start point, t coordinate of start point), (x coordinate of end point, y coordinate of end point, t coordinate of end point)]. Then, a list of links is a set of such links.

Herein, a set of links is assumed to express a list of links in { }. For example, a list of links such as {[(0, 0, 0), (100, 100, 100)], [(100, 100, 100), (100, 200, 200)]} may be created as a list of links of the aircraft of interest, and a list of links such as {[(0, 0, −100), (50, 0, 0)], [(50, 0, 0), (50, 100, 100)]} may be created as a list of links of the peripheral aircraft.

The link creation means 23 performs processing of specifying a link pair having a common part between the time from the start point time to the end point time of the link of the aircraft of interest and the time from the start point time to the end point time of the link of the peripheral aircraft.

The geometric model generation means 21 and the conflict detection means 22 perform processing of determining presence of conflict per such link pair.

The link creation means 23 is realized by the CPU in a computer operating according to the moving-body-abnormal-nearing detection program, for example. The link creation means 23 may be realized by different hardware from other components.

Processing progress according to the second exemplary embodiment will be described below. FIG. 7 is a flowchart illustrating exemplary processing progress according to the second exemplary embodiment of the present invention. The input device 1 is input with the flight plan of the aircraft of interest, the flight plan of the peripheral aircraft, and the oceanic airspace. The input device 1 sends the two flight plans to the link creation means 23, and sends the oceanic airspace to the conflict detection means 22.

The link creation means 23 creates a list of links of the aircraft of interest from the flight plan of the aircraft of interest, and creates a list of links of the peripheral aircraft from the flight plan of the peripheral aircraft (step B1).

Then, the link creation means 23 scans the list of links of the aircraft of interest and the list of links of the peripheral aircraft, respectively, and generates a list of link pairs which each includes a link of the aircraft of interest and a link of the peripheral aircraft and meet the condition that “a common part is present between the time from the start point time to the end point time of the link of the aircraft of interest and the time from the start point time to the end point time of the link of the peripheral aircraft” (step B2). The link creation means 23 inputs the list of link pairs into the geometric model generation means 21.

When the start point times of the two links in a link pair meeting the above condition are different, the link creation means 23 updates the start point coordinate (x, y, t) of the link at the earlier start point time such that the start point time t is the same as the start point time of the other link. The update processing has been described in the first exemplary embodiment, and thus a description thereof will be omitted. As a result, the start point time of the link of the aircraft of interest is common with the start point time of the link of the peripheral aircraft in each link pair input into the geometric model generation means 21.

The geometric model generation means 21 calculates the projection matrix m indicating mapping from the 3D space onto the calculation plane and the projection matrix M indicating its inverse mapping per input individual link pair.

The geometric model generation means 21 then inputs the link pairs and all the pairs of two projection matrices m and M calculated from the link pairs into the conflict detection means 22.

The conflict detection means 22 selects one pair from the input link pairs and the pairs of projection matrices m and M. The conflict detection means 22 then maps the link of the aircraft of interest expressed in the 3D space onto the calculation plane for the pair by use of the projection matrix m, and calculates a line segment s as a mapping result of the link of the aircraft of interest. The conflict detection means 22 then determines how the circle c in the calculation plane whose center is the start point of the link of the peripheral aircraft and whose radius is the oceanic airspace crosses with the line segment s (step A3). The crossing determination processing is the same as in step A3 according to the first exemplary embodiment.

As a result of the crossing determination in step A3, when determining that the circle c does not cross with the line segment s (NO in step A4), the conflict detection means 22 determines whether the processing in step A3 is performed on all combinations of a link pair and matrices m and M (step B4).

When a combination of a link pair and matrices m and M not subjected to the processing in step A3 remains (NO in step B4), the conflict detection means 22 selects one pair from the pairs, and performs the processing in step A3 thereon again.

When the processing in step A3 is completed for all the input combinations of a link pair and matrices m and M (YES in step B4), the conflict detection means 22 sends the determination result that a conflict will not occur to the conflict detection result output device 3, and the conflict detection result output device 3 outputs the determination result (step A6).

As a result of the crossing determination in step A3, when determining that the circle c crosses with the line segment s (YES in step A4), the conflict detection means 22 maps the cross points between the circle c and the line segment s into the 3D space by use of the projection matrix M thereby to generate conflict information (information on an occurrence time and an occurrence place of the conflict) (step A5). The processing is the same as step A5 according to the first exemplary embodiment.

After step A5, the conflict detection means 22 sends the determination result that a conflict will occur and the conflict information to the conflict detection result output device 3, and the conflict detection result output device 3 outputs the determination result and the conflict information (step A6).

The present exemplary embodiment can also obtain the same effects as those in the first exemplary embodiment.

### Third Exemplary Embodiment

FIG. 8 is a block diagram illustrating an exemplary structure of the moving-body-abnormal-nearing detection system according to a third exemplary embodiment of the present invention. The same components as those in the first exemplary embodiment and the second exemplary embodiment are denoted with the same reference numerals as in FIG. 1 and FIG. 6, and a detailed description thereof will be omitted. In the third exemplary embodiment, the data processing device 2 includes the geometric model generation means 21, the conflict detection means 22 and an avoidance information calculation means 24.

The following description will be made by way of a case in which the input device 1 is input with link pairs and safe distance information similarly as in the first exemplary embodiment.

When the conflict detection means 24 determines that a conflict will occur between the aircraft of interest and the peripheral aircraft based on the crossing determination between the line segment s and the circle c, the avoidance information calculation means 24 calculates avoidance information by use of the line segment s, the circle c and the projection matrix M. The avoidance information indicates an arrival time of the end point of the link of the aircraft of interest or a speed of the aircraft of interest in order to avoid a conflict.

In the present exemplary embodiment, for example, the input device 1 may be input with aircraft-of-interest designation information indicating which of the two links input as a link pair is the link of the aircraft of interest (or aircraft for which avoidance information is to be calculated). In this case, the geometric model generation means 21, the conflict detection means 21 and the avoidance information calculation means 24 may perform the processing assuming one link designated as being of the aircraft of interest by the aircraft-of-interest designation information as the link of the aircraft of interest and the other link as the link of the peripheral aircraft. In this case, the avoidance information calculation means 24 calculates avoidance information for the link designated as being of the aircraft of interest.

Alternatively, after terminating the processing assuming one of the two links as the link of the aircraft of interest and the other link as the link of the peripheral aircraft, the geometric model generation means 21, the conflict detection means 21 and the avoidance information calculation means 24 may perform the same processing again by switching the aircraft of interest and the peripheral aircraft. In this case, when a conflict may occur, avoidance information can be obtained for the two links, respectively.

The following description will be made by way of a case in which the input device 1 is input with aircraft-of-interest designation information.

The avoidance information calculation means 24 is realized by the CPU in a computer operating according to the moving-body-abnormal-nearing detection program, for example. The avoidance information calculation means 24 may be realized by different hardware from other components.

Processing progress according to the third exemplary embodiment will be described below. FIG. 9 is a flowchart illustrating exemplary processing progress according to the third exemplary embodiment of the present invention. The input device 1 is input with the link pairs extracted from the flight plans of two aircrafts, the oceanic airspace and the aircraft-of-interest designation information from the manager. The input device 1 sends the link pairs and the aircraft-of-interest designation information to the geometric model generation means 21, and sends the oceanic airspace to the conflict detection means 22.

The geometric model generation means 21 determines whether a common part is present between the time from the start point time to the end point time of one link in the link pair and the time from the start point time to the end point time of the other link (step A1).

When a common part is not present between the times of the two links (NO in step A1), the geometric model generation means 21 sends the determination result that a conflict will not occur to the conflict detection result output device 3, and the conflict detection result output device 3 outputs the determination result (step A6).

When a common part is present between the times of the two links (YES in step A1), the geometric model generation means 21 calculates the projection matrix m indicating mapping from the 3D space onto the calculation plane P_{c} and the projection matrix M indicating its inverse mapping based on the link of the aircraft of interest and the link of the peripheral aircraft (step A2). At this time, one link in the link pair designated by the aircraft-of-interest designation information may be assumed as the link of the aircraft of interest, and the other link may be assumed as the link of the peripheral aircraft. The geometric model generation means 21 then inputs the link of the aircraft of interest, the link of the peripheral aircraft, and the projection matrices m and M into the conflict detection means 22 (step A2). The method for calculating the projection matrices M and m is the same as in the first exemplary embodiment.

After step A2, the conflict detection means 22 maps the link of the aircraft of interest expressed in the 3D space onto the calculation plane P_{c} by use of the projection matrix m, and calculates a line segment s as a mapping result of the link of the aircraft of interest. The conflict detection means 22 then determines how the circle c in the calculation plane whose center is the start point of the link of the peripheral aircraft and whose radius is the oceanic airspace crosses with the line segment s (step A3).

As a result of the crossing determination in step A3, when determining that the circle c does not cross with the line segment s (NO in step A4), the conflict detection means 22 sends the determination result that a conflict will not occur to the conflict detection result output device 3, and the conflict detection result output device 3 outputs the determination result (step A6).

As a result of the crossing determination in step A3, when determining that the circle c crosses with the line segment s (YES in step A4), the conflict detection means 22 maps the cross points between the circle c and the line segment s into the 3D space by use of the projection matrix M thereby to generate conflict information (information on an occurrence time and an occurrence place of the conflict) (step A5). Steps A3 to A5 are the same as steps A3 to A5 in the first exemplary embodiment.

The conflict detection means 22 then sends the determination result that a conflict will occur to the conflict detection result output device 3.

Further, the conflict detection means 22 inputs the information on the line segment s and the circle c, and the projection matrix M into the avoidance information calculation means 24. The avoidance information calculation means 24 calculates the coordinate of a point of contact between the tangent line of the circle c passing through the start point of the line segment s and the circle c in the calculation plane. The avoidance information calculation means 24 maps the coordinate of the point of contact into the 3D space by use of the projection matrix M. The avoidance information calculation means 24 then calculates the t coordinate passing through the start point of the link FA and its mapped point and corresponding to the x coordinate x_{A2} and the y coordinate y_{A2} at the end point of the link FA (step C1). The t coordinate indicates an arrival time at the end point of the link of the aircraft of interest in order to avoid a conflict, and corresponds to avoidance information.

FIG. 10 is an explanatory diagram schematically illustrating the processing in step C1. The same components as in FIG. 2 are denoted with the same reference numerals as in FIG. 2. In FIG. 10, the tangent lines R₁ and R₂ are of the circle c passing through the start point of the line segment s in the calculation plane P_{c}. The avoidance information calculation means 24 calculates the coordinates of the point of contact Rₚ₁ between the tangent line R₁ and the circle c and the point of contact Rₚ₂ between the tangent line R₂ and the circle c. The avoidance information calculation means 24 then maps the coordinates of the points of contact Rₚ₁ and Rₚ₂ into the 3D space by use of the projection matrix M. The calculations are the same as the calculations for mapping the cross points between the line segment s and the circle c in step A5. That is, assuming the coordinate of the point of contact as (xᵣ, yᵣ), the avoidance information calculation means 24 defines a vector of P=(xᵣ, yᵣ, t_{A1}, 1), and finds the coordinate with the x coordinate p·M1, the y coordinate p·M2 and the t coordinate p·M3 in the 3D space. In FIG. 10, the mapped point of contact Rₚ₁ is indicated as point Rₚ₁′ and the mapped point of contact Rₚ₂ is indicated as point Rₚ₂′. The points Rₚ₁′ and Rₚ₂′ are the points of contact between the tangent line of the oval d passing through the start point of the link FA and the oval d. The avoidance information calculation means 24 calculates the t coordinate (or the t coordinate of the point E₃) passing through the start point of the link FA and the point Rₚ₁′ and corresponding to the x and y coordinates (100, 100) at the end point of the link FA. Similarly, the avoidance information calculation means 24 calculates the t coordinate (or the t coordinate of the point E₄) passing through the start point of the link FA and the point Rₚ₂′ and corresponding to the x and y coordinates (100, 100) at the end point of the link FA.

The t coordinate at the point E₃ is an arrival time where a conflict can be avoided when a speed of the aircraft of interest is accelerated in order to avoid a conflict. The t coordinate at the point E₄ is an arrival time when a conflict can be avoided when a speed of the aircraft of interest is decelerated in order to avoid a conflict.

The avoidance information calculation means 24 may calculate a speed of the aircraft of interest in order to avoid a conflict based on a distance and a temporal difference on the plane capable of being derived from the coordinates of the start point of the link FA and the point E₃. The speed is a conflict avoidance speed when the speed of the aircraft of interest is accelerated. Similarly, the avoidance information calculation means 24 may calculate a speed of the aircraft of interest in order to avoid a conflict based on a distance and a temporal difference on the plane capable of being derived from the coordinates of the start point of the link FA and the point E₄. The speed is a conflict avoidance speed when the speed of the aircraft of interest is decelerated.

After step C1, the avoidance information calculation means 24 sends, as avoidance information, the arrival time at the end point of the link of the aircraft of interest capable of avoiding a conflict to the conflict detection result output device 3. The avoidance information calculation means 24 may send the conflict avoidance speed as avoidance information to the conflict detection result output device 3. The conflict detection result output device 3 then outputs the determination result that a conflict will occur and the avoidance information (step A6).

In the present exemplary embodiment, in addition to the same effects as in the first exemplary embodiment, there is also obtained an effect that avoidance information for avoiding a conflict can be calculated with less calculation. In the present exemplary embodiment, the avoidance information calculation means 24 calculates the points of contact between the circle c and the tangent lines R₁ and R₂ in the calculation plane, and maps the points of contact into the 3D space. The calculations for calculating the points of contact are made in the calculation plane, which requires less calculation. Further, the processing of mapping the points of contact from the calculation plane into the 3D space requires simple matrix calculations. Thus, avoidance information can be obtained in a shorter processing time.

The third exemplary embodiment may be applied to the second exemplary embodiment. That is, the data processing device 2 according to the second exemplary embodiment may include the avoidance information calculation means 24. In this case, the avoidance information calculation means 24 may perform the processing in step C1 similarly as in the third exemplary embodiment after step AS illustrated in FIG. 7.

The aircrafts have been assumed as exemplary moving bodies in each of the above exemplary embodiments, but the present invention can be applied for determining a movement plan of a moving body (such as train or bus) other than aircrafts. Further, it can be applied for detecting abnormal nearing between moving machines operating in a plant or work place, and can be used for preventing the moving machines.

A minimum structure of the present invention will be described below. FIG. 11 is a block diagram illustrating an exemplary minimum structure of the present invention. The moving-body-abnormal-nearing detection system according to the present invention includes a projection matrix calculation means 71 and an abnormal nearing determination means 72.

The projection matrix calculation means 71 (the geometric model generation means 21, for example) calculates a first projection matrix (such as projection matrix m) indicating mapping from a 3D space onto a 2D plane based on period information of a first moving body (link of the aircraft of interest, for example) having a 3D coordinate with the coordinate values of the 2D coordinates of a passage position of the first moving body and its passage time as information on the start point and the end point of the period, and period information of a second moving body (link of the peripheral aircraft, for example) having a 3D coordinate with the coordinate values of the 2D coordinates of a passage position of the second moving body and its passage time as information on the start point and the end point of the period.

The abnormal nearing determination means 72 (the conflict detection means 22, for example) determines whether abnormal nearing between the first moving body and the second moving body will occur by mapping the period information of the first moving body to a line segment (line segment s, for example) in the 2D plane by use of the first projection matrix, and determining how a circle (circle c, for example) whose center is a passage position of the second moving body and whose radius is a threshold for determination standard (such as oceanic airspace) as to whether abnormal nearing occurs crosses with the line segment in the 2D plane.

With the structure, a distance between the two moving bodies does not need to be calculated per time, and thus a determination as to whether abnormal nearing between the moving bodies will occur can be made in a shorter processing time.

The projection matrix calculation means 71 may calculate a second projection matrix (such as projection matrix M) indicating mapping from the 2D plane into the 3D space based on the period information of the first moving body and the period information of the second moving body, and as a result of the crossing determination between the circle and the line segment, when determining that abnormal nearing between the first moving body and the second moving body will occur, the abnormal nearing determination means 72 may calculate a passage position of the first moving body when the abnormal nearing occurs and a time when the abnormal nearing will occur by mapping the cross points between the circle and the line segment into the 3D space by use of the second projection matrix.

There may be provided an avoidance information calculation means (the avoidance information calculation means 24, for example) which calculates the coordinate of a point of contact between the tangent line of the circle passing through the start point of the line segment and the circle when it is determined that abnormal nearing between the first moving body and the second moving body will occur as a result of the crossing determination between the circle and the line segment, maps the coordinate of the point of contact to a point in the 3D space by use of the second projection matrix, and calculates an end point arrival time of the first moving body or a speed of the first moving body capable of avoiding abnormal nearing based on the coordinate of the point.

There may be provided a period information creation means (the link creation means 23, for example) for generating a list of period information of the first moving body from a movement plan of the first moving body, generating a list of period information of the second moving body from a movement plan of the second moving body, and specifying a pair of period information of the first moving body and period information of the second moving body which have common part in the times from the start point time to the end point time, and there may be configured such that the projection matrix calculation means 71 calculates at least the first projection matrix for each pair of period information of the first moving body and period information of the second moving body specified by the period information creation means, and the abnormal nearing determination means 72 sequentially selects a pair of period information of the first moving body and period information of the second moving body specified by the period information creation means and determines whether abnormal nearing between the first moving body and the second moving body will occur for the selected pair.

The present application claims the priority based on Japanese Patent Application No. 2012-133864 filed on Jun. 13, 2012, the disclosure of which is all incorporated herein by reference.

The present invention has been described above with reference to the exemplary embodiments, but the present invention is not limited to the above exemplary embodiments. The structure and details of the present invention can be variously changed within the scope of the present invention understandable by those skilled in the art.

### INDUSTRIAL APPLICABILITY

The present invention is suitably applied to a moving-body-abnormal-nearing detection system for detecting abnormal nearing between moving bodies.

### REFERENCE SIGNS LIST

1 Input device
3 Conflict detection result output device
21 Geometric model generation means
22 Conflict detection means
23 Link creation means
24 Avoidance information calculation means

What is claimed is:

1. A moving-body-abnormal-nearing detection system comprising:
a projection matrix calculation unit for calculating a first projection matrix indicating mapping from a 3D space onto a 2D plane based on period information of a first moving body having a 3D coordinate with the coordinate values of a 2D coordinate of a passage position of the first moving body and a passage time as information on the start point and the end point of the period and period information of a second moving body having a 3D coordinate with the coordinate values of a 2D coordinate of a passage position of the second moving body and a passage time as information on the start point and the end point of the period; and
an abnormal nearing determination unit for mapping the period information of the first moving body to a line segment in the 2D plane by use of the first projection matrix, and determining how a circle whose center is a passage position of the second moving body and whose radius is a threshold as a determination standard as to whether abnormal nearing will occur crosses with the line segment in the 2D plane, thereby determining whether abnormal nearing between the first moving body and the second moving body will occur.

2. The moving-body-abnormal-nearing detection system according to claim 1,
wherein the projection matrix calculation unit calculates a second projection matrix indicating mapping from the 2D plane into the 3D space based on the period information of the first moving body and the period information of the second moving body, and
as a result of the crossing determination between the circle and the line segment, when determining that abnormal nearing between the first moving body and the second moving body will occur, the abnormal nearing determination unit maps the coordinates of the cross points between the circle and the line segment into the 3D space by use of the second projection matrix, thereby calculating a passage position of the first moving body when abnormal nearing occurs and a time when the abnormal nearing will occur.

3. The moving-body-abnormal-nearing detection system according to claim 2, further comprising:
an avoidance information calculation unit for calculating a coordinate of a point of contact between a tangent line of the circle passing through the start point of the line segment and the circle when it is determined that abnormal nearing between the first moving body and the second moving body will occur as a result of the crossing determination between the circle and the line segment, mapping the coordinate of the point of contact to a point in the 3D space by use of the second projection matrix, and calculating an end point arrival time of the first moving body or a speed of the first moving body capable of avoiding abnormal nearing based on the coordinate of the point.

4. The moving-body-abnormal-nearing detection system according to claim 1, comprising:
a period information creation unit for generating a list of period information of the first moving body from a movement plan of the first moving body, generating a list of period information of the second moving body from a movement plan of the second moving body, and specifying a pair of period information of the first moving body and period information of the second moving body which have common part in the times from the start point time to the end point time,
wherein the projection matrix calculation unit calculates at least a first projection matrix for each pair of period information of the first moving body and period information of the second moving body specified by the period information creation unit, and
the abnormal nearing determination unit sequentially selects a pair of period information of the first moving body and period information of the second moving body specified by the period information creation unit and determines whether abnormal nearing between the first moving body and the second moving body will occur for the selected pair.

5. A moving-body-abnormal-nearing detection method comprising the steps of:
calculating a first projection matrix indicating mapping from a 3D space onto a 2D plane based on period information of a first moving body having a 3D coordinate with the coordinate values of a 2D coordinate of a passage position of the first moving body and a passage time as information on the start point and the end point of the period and period information of a second moving body having a 3D coordinate with the coordinate values of a 2D coordinate of a passage position of the second moving body and a passage time as information on the start point and the end point of the period; and
mapping the period information of the first moving body to a line segment in the 2D plane by use of the first projection matrix, and determining how a circle whose center is a passage position of the second moving body and whose radius is a threshold as a determination standard as to whether abnormal nearing will occur crosses with the line segment in the 2D plane, thereby determining whether abnormal nearing between the first moving body and the second moving body will occur.

6. The moving-body-abnormal-nearing detection method according to claim 5, comprising the steps of:
calculating a second projection matrix indicating mapping from the 2D plane into the 3D space based on the period information of the first moving body and the period information of the second moving body; and
when it is determined that abnormal nearing between the first moving body and the second moving body will occur as a result of the crossing determination between the circle and the line segment, mapping the coordinates of the cross points between the circle and the line segment into the 3D space by use of the second projection matrix, thereby calculating a passage position of the first moving body when abnormal nearing occurs and a time when the abnormal nearing will occur.

7. A non-transitory computer readable recording medium in which a moving-body-abnormal-nearing detection program is recorded, the moving-body-abnormal-nearing detection program causing a computer to perform:
projection matrix calculation processing of calculating a first projection matrix indicating mapping from a 3D space onto a 2D plane based on period information of a first moving body having a 3D coordinate with the coordinate values of a 2D coordinate of a passage position of the first moving body and a passage time as information on the start point and the end point of the period and period information of a second moving body having a 3D coordinate with the coordinate values of a 2D coordinate of a passage position of the second moving body and a passage time as information on the start point and the end point of the period; and
abnormal nearing determination processing of mapping the period information of the first moving body to a line segment in the 2D plane by use of the first projection matrix, and determining how a circle whose center is a passage position of the second moving body and whose radius is a threshold as a determination standard as to whether abnormal nearing will occur crosses with the line segment in the 2D plane, thereby determining whether abnormal nearing between the first moving body and the second moving body will occur.

8. The non-transitory computer readable recording medium in which the moving-body-abnormal-nearing detection program is recorded according to claim 7, the program causing a computer to perform:
projection matrix calculation processing of calculating a second projection matrix indicating mapping from the 2D plane into the 3D space based on the period information of the first moving body and the period information of the second moving body; and
abnormal nearing determination processing of, when it is determined that abnormal nearing between the first moving body and the second moving body will occur as a result of the crossing determination between the circle and the line segment, mapping the coordinates of the cross points between the circle and the line segment into the 3D space by use of the second projection matrix, thereby calculating a passage position of the first moving body when abnormal nearing occurs and a time when the abnormal nearing will occur.
